(19) United States
(12) Patent Application Publication
(10) Pub. No.: US 2002/0196242 A1
(43) Pub. Date: Dec. 26, 2002

(54) Display apparatus and signal processing method thereof

(75) Inventor: Hirotsuna Miura, Suwa-gun (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/155,974

(22) Filed: May 29, 2002

(30) Foreign Application Priority Data
Jun. 5, 2001 (JP) 2001-169168

(51) Int. Cl. G09G 5/00

(52) U.S. Cl. 345/204

(57) ABSTRACT

The invention provides a display apparatus and a signal processing method thereof, which reduces or suppresses display irregularities without using thermal sensors and is capable of performing higher quality display. Tables of heat generation patterns of a display device and display characteristic functions (or tables) of liquid crystal are stored in a ROM in advance. When a process is started, a process content judging section judges process contents based on a task being currently executed. A CPU compares the judged process contents with the tables of heat generation patterns to obtain an amount of heat generation at each of pixel locations. Next, an image correction section compares the amount of heat generation at each of pixel locations with the voltage-optical characteristic functions and obtain an amount of correction of voltage to be applied to each of the pixels, whereby the voltage for each of the pixels is corrected.

### BACKGROUND OF THE INVENTION

1. Field of Invention

The present invention relates to a display apparatus that is implemented in a mobile information terminal or the like and a signal processing method thereof. In particular, the present invention relates to a display apparatus and a signal processing method thereof that reduces or suppresses display irregularities and performs higher quality displays.

2. Description of Related Art

Recently, electronic apparatuses, including personal computers and mobile information terminals (such as personal digital assistants (PDAs)), have become very popular. Liquid crystal displays (LCDs) are one of display devices used for these electronic apparatuses. Since liquid crystal displays are low power consumption devices and can be made to be thin, they are used for notebook-type personal computers and PDAs. Various types of displays, such as STN color liquid crystal, DSTN color liquid crystal and TFT color liquid crystal, which differ from one another based upon their systems for driving liquid crystal of liquid crystal displays, have been developed.

A liquid crystal display is a display that uses a liquid crystal panel at its display section, and is formed of an assembly of glass plates that sandwich liquid crystal and polarizing filters. The liquid crystal that forms the liquid crystal panel is a material that has characteristics intermediate of those of liquid and solid, and changes orientations of its molecules depending on changes in the applied voltage, such that transmission of light can be controlled. For this reason, the amount of luminescence of the liquid crystal panel and the like can be controlled by controlling the voltage that is applied to the liquid crystal.

In a mobile information terminal or the like, a substrate, that is equipped with a CPU and the like that controls the mobile information terminal, may be disposed on the rear surface of the liquid crystal display.

FIG. 10 is a schematic that shows the liquid crystal display and a substrate.

FIG. 10 shows, at its bottom section, a substrate 104 that is equipped with a CPU 102 that controls the mobile information terminal, and a communication section 103 that performs communication with external apparatuses and the like. A liquid crystal display 106 is provided above, and spaced a distance from, the substrate 104 with column-shaped fixed members 105 being interposed between them. In FIG. 10, as the CPU 102 performs calculations, and the communication section 103 operates to communicate with external apparatuses, heat is generated from the CPU 102 and the communication section 103. The heat is conducted to the liquid crystal display 106 that is spaced a certain distance from the CPU 102 and the communication section 103. In FIG. 10, a temperature distribution of the liquid crystal display 106 is shown with color gradations. It is noted that, in this example, the CPU 102 has a greater heat generation than the communication section 103, and therefore causes a greater temperature elevation on the liquid crystal display 106.

The voltage-optical characteristics of liquid crystal (two-terminal elements in FIG. 2) that forms the liquid crystal display 106 change according to temperatures of the liquid crystal. Accordingly, when the temperature distribution on the liquid crystal display 106 changes, displayed colors (contrast, brightness, color tone in the case of color display and the like) of the liquid crystal display 106 change. Normally, since a CPU or the like that is a source of heat generation is generally smaller in size than the display area of the liquid crystal display 106, localized display irregularities occur for the liquid crystal display.

To reduce the display irregularities, a method that uses thermal sensors to measure temperatures adjacent to the liquid crystal has been proposed. This method uses multiple thermal sensors that are disposed on the rear surface of the liquid crystal display, and controls voltages to be applied to various sections of the liquid crystal based on measured temperatures. However, this method requires multiple thermal sensors, which hinders miniaturization of apparatuses.

### SUMMARY OF THE INVENTION

The present invention addresses the problems described above, and provides a display apparatus and a signal processing method thereof, which reduces or suppresses display irregularities and is capable of performing higher quality display without using thermal sensors.

To address the problems described above, a display apparatus in accordance with the present invention includes: a display device having a display characteristic that changes according to temperatures; a driver device that drives the display device; an image processing device that processes image data to be displayed on the display device; a process content judging device that judges a process content based on a task of each of devices that form a system; a storage device that stores a table of heat generation pattern of the display device and a display characteristic function (or table) of the display device according to the process content; an image correction device that calculates a driving correction amount at each of pixels on the display device based on a judgment content provided by the process content judging device, the heat generation pattern and the display characteristic function; and a control device that controls the entire system.

A signal processing method in accordance with the present invention includes: storing a table of heat generation pattern of a display device and a display characteristic function (or table) of the display device according to a task process content of each of devices that form a system; judging the task process content during execution of the task; comparing a process content judged with the table of heat generation pattern to calculate an amount of heat generation at each of pixel locations on the display device; comparing the amount of heat generation at each of the pixel locations with the display characteristic function to obtain a driving correction amount at each of the pixel locations on the display device; and correcting a driving amount for each of the pixels.

Since the table of heat generation pattern and the display characteristic function (or table) of the display device are used to obtain a driving correction amount at each of the pixel locations on the display device, display irregularities of the display device can be reduced or suppressed without using thermal sensors, and a higher quality display can be conducted. It is noted that, when liquid crystal is used as the display device, voltage-optical characteristic functions (or tables) can be used as the display characteristic functions. Also, depending on display devices, current control or pulse width control can be used instead of the voltage control, and therefore current-optical characteristic functions or pulse width-optical characteristic functions may also be used as display characteristic functions.

### BRIEF DESCRIPTION OF THE DRAWINGS

FIG. 1 is a block diagram of a structure of a liquid crystal display apparatus in accordance with an embodiment of the present invention;

FIG. 2 is a schematic of an equivalent circuit of the liquid crystal panel 10 shown in FIG. 1;

FIG. 3 is a graph showing an applied voltage-brightness characteristic of the two-terminal element 10b;

FIG. 4 is a graph showing an applied voltage-transmittivity characteristic of the two-terminal element 10b;

FIG. 5 is a graph showing an applied voltage-reflectance characteristic of the two-terminal element 10b;

FIG. 6 is an exploded perspective view of a liquid crystal display apparatus and a liquid crystal panel in accordance with an embodiment of the present invention;

FIG. 7 is a schematic showing temperature distributions of the liquid crystal panel 10 shown in FIG. 6;

FIG. 8 is a chart that shows a heat generation pattern to be formed when a certain operation is performed by the CPU 2;

FIG. 9 is a flowchart of a signal processing method for the liquid crystal display apparatus in accordance with an embodiment of the present invention; and

FIG. 10 is a schematic that shows a liquid crystal display and a substrate.

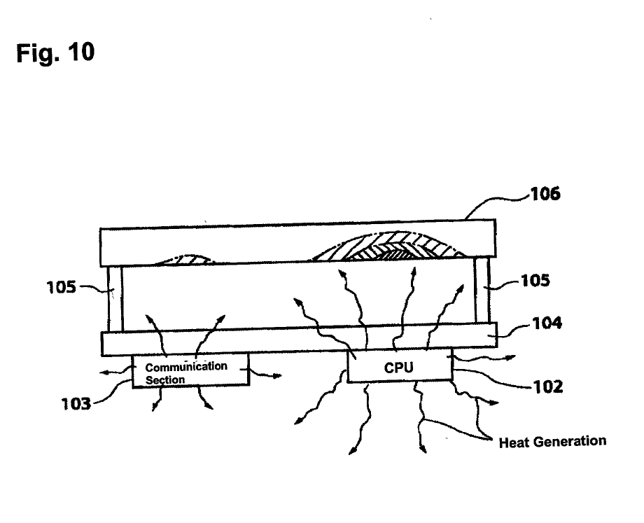

### DETAILED DESCRIPTION OF PREFERRED EMBODIMENTS

Descriptions are provided below with reference to the accompanying drawings. It is noted that an example in which liquid crystal is used as a display device will be explained. However, the present invention is not limited to this example, and is also applicable to other cases that use, for example, organic EL, plasma display and the like.

First, a liquid crystal display apparatus in accordance with an embodiment of the present invention will be described.

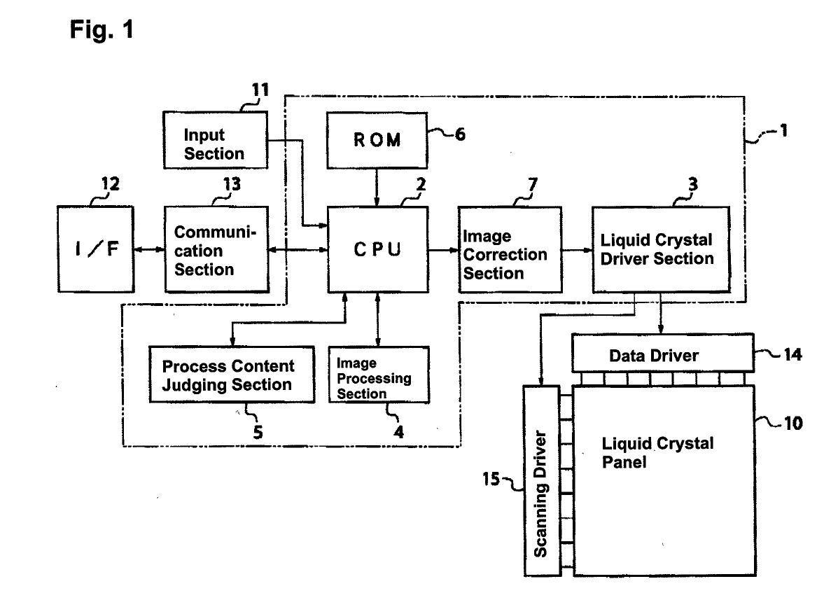

FIG. 1 is a block diagram of a structure of a liquid crystal display apparatus in accordance with an embodiment of the present invention.

FIG. 1 shows a liquid crystal display apparatus 1 that realizes predetermined functions of a mobile information terminal and controls display of a liquid crystal display (hereafter “liquid crystal panel”), a liquid crystal panel 10 that displays data, an input section 11 that inputs commands and setting values in the liquid crystal display apparatus 1, and a communication section 13 that performs data communication with external devices through an I/F (interface) 12. The liquid crystal panel 10 is connected to a scanning driver 15 that applies voltages to scanning signal lines and a data driver 14 that applies voltages to data signal lines, which will be described in greater detail below.

The liquid crystal display apparatus 1 is provided with a CPU (control section) 2 that controls the entire system, a liquid crystal driver section 3 that drives the liquid crystal display 10, an image processing section 4 that processes image data to be displayed on the liquid crystal display 10, a process content judging section 5 that judges process contents based on tasks (threads, processes) of devices that form the system, and a ROM (storage section) 6 that stores a table of heat generation patterns that are created taking into account dispositions (positions on the substrate, distances to the liquid crystal display and the like) of the devices, and amounts of heat generation, heat resistances and the like of the devices, and voltage-optical characteristic functions (or tables) of liquid crystal that forms the liquid crystal display 10. An image correction section 7 is provided between the CPU 2 and the liquid crystal driver section 3. The image correction section 7 calculates an amount of correction of voltage to be applied to each of the pixels on the liquid crystal display 10 based on judged contents provided by the process content judging section 5, and the table of heat generation patterns and the voltage-optical characteristic functions stored in the ROM 6. Image data outputted from the CPU 2 is corrected at the image correction section 7, and displayed on the liquid crystal display 10.

Any one of various systems, such as an STN system, a DSTN system and a TFT system may be used for the liquid crystal panel 10. Here, an active matrix driving system will be described as an example, which uses two-terminal nonlinear elements, typical MIM (Metal Insulator Metal) elements, as switching elements.

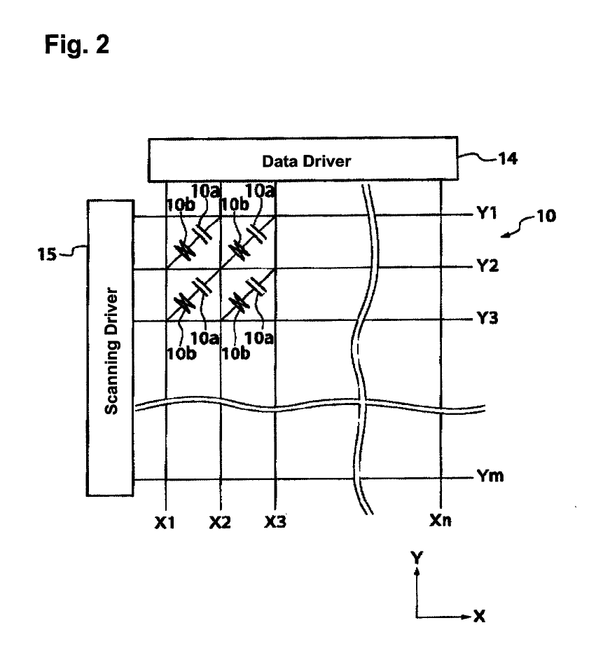

FIG. 2 is a schematic of an equivalent circuit of the liquid crystal panel 10 shown in FIG. 1.

FIG. 2 shows a matrix of pixels of the liquid crystal panel. In FIG. 2, although a part thereof is omitted in this example, n number of data signal lines X1-Xn in an X direction and m number of scanning signal lines Y1-Ym are disposed. A two-terminal element 10b and a liquid crystal layer 10a, serially connected to each other, are disposed in each of the pixels. The data signal lines X1-Xn are connected to the data driver 14, and the scanning signal lines Y1-Ym are connected to the scanning driver 15.

The data driver 14 applies predetermined voltages according to display data to the data signal lines X1-Xn, and is formed of a shift register, a latch circuit, an analog switch device and the like. Also, the scanning driver 15 successively applies predetermined voltages to the scanning signal lines Y1-Ym, and is formed of a liquid crystal driver power supply circuit, a shift register, an analog switch device and the like.

The voltage-optical characteristics of the two-terminal element 10b change depending on temperatures.

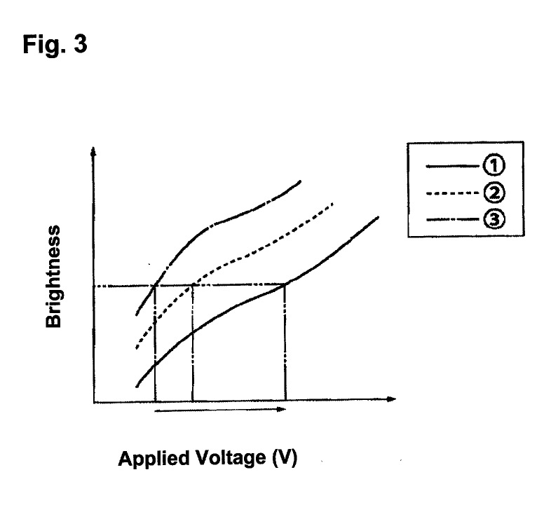

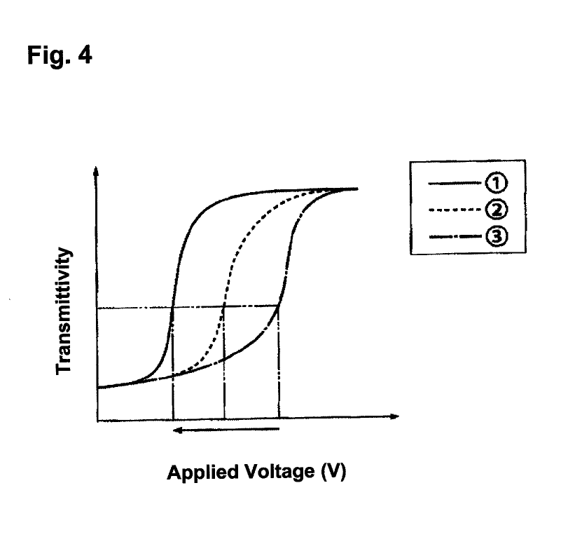

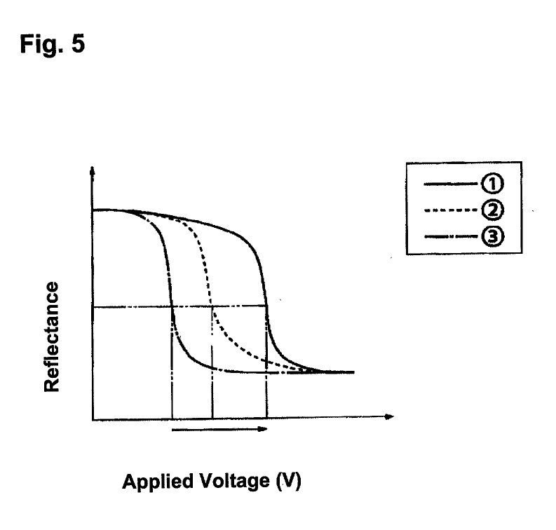

FIG. 3 is a graph showing an applied voltage-brightness characteristic of the two-terminal element 10b. FIG. 4 is a graph showing an applied voltage-transmittivity characteristic of the two-terminal element 10b. FIG. 5 is a graph showing an applied voltage-reflectance characteristic of the two-terminal element 10b. In FIGS. 3-5, signs \mathring{1}, \mathring{2} and \mathring{3} indicate higher to lower temperatures, respectively. It is noted that the characteristics shown in FIGS. 3-5 are examples, and they differ depending on types of two-terminal elements.

As shown in FIG. 3, the brightness of the two-terminal element 10b tends to become greater as the applied voltage becomes greater. Also, the brightness thereof tends to lower as the temperature of the two-terminal element 10b elevates. For this reason, when the temperature of the two-terminal element 10b elevates, the voltage to be applied may be made to be greater to obtain an appropriate brightness.

As shown in FIG. 4, the transmittivity of the two-terminal element 10b tends to increase as the applied voltage becomes greater. Also, the transmittivity thereof tends to increase as the temperature of the two-terminal element 10b elevates. For this reason, when the temperature of the two-terminal element 10b elevates, the voltage to be applied may be made to be smaller to obtain an appropriate brightness.

As shown in FIG. 5, the reflectance of the two-terminal element 10b tends to lower as the applied voltage becomes greater. Also, the reflectance thereof tends to increase as the temperature of the two-terminal element 10b elevates. For this reason, when the temperature of the two-terminal element 10b elevates, the voltage to be applied may be made to be greater to obtain an appropriate brightness.

In this manner, by controlling the voltages to be applied to the two-terminal elements 10b, displayed colors (contrast, brightness, and color tone in the case of color display) of the liquid crystal panel 10 can be adjusted. It is noted that the voltage-optical characteristic functions (or tables) of the two-terminal element 10b are stored in the ROM 6 described above.

Next, a description is provided as to the table of heat generation patterns that take into account dispositions (positions on the substrate, distances to the liquid crystal display and the like), amounts of heat generation and heat resistances and the like of the devices that form the system, which is stored in the ROM 6 described above.

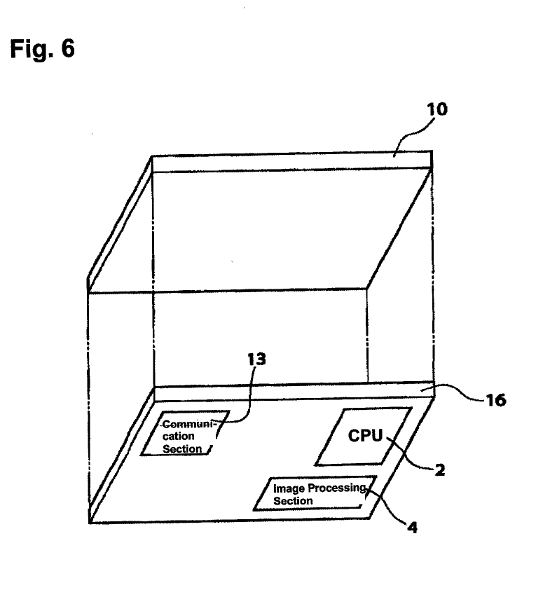

FIG. 6 is an exploded perspective view of a liquid crystal display apparatus and a liquid crystal panel in accordance with the embodiment of the present invention.

FIG. 6 shows a substrate 16 that is provided with the CPU 2 (see FIG. 1), the image processing section 4 (see FIG. 1), the communication section 13 (see FIG. 1) and the like, and the liquid crystal panel 10 (see FIG. 1) disposed on the substrate 16.

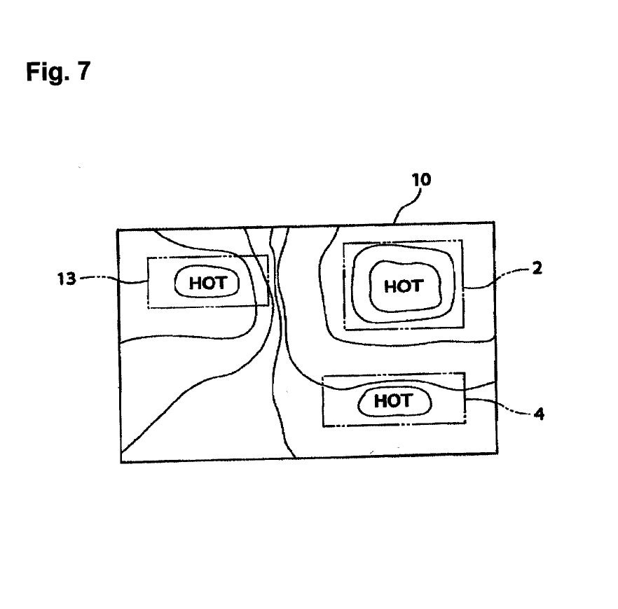

FIG. 7 is a schematic showing temperature distributions on the liquid crystal panel 10 shown in FIG. 6.

In this example, when the CPU 2 performs operations, the communication section 13 performs communication with external apparatuses, or the image processing section 4 performs image processing, heat is generated. FIG. 7 shows a temperature distribution with contour lines centered on each of these heat generation sources. The temperature distribution changes according to process contents performed by the system.

A table of heat generation patterns according to the process contents described above is created for each process.

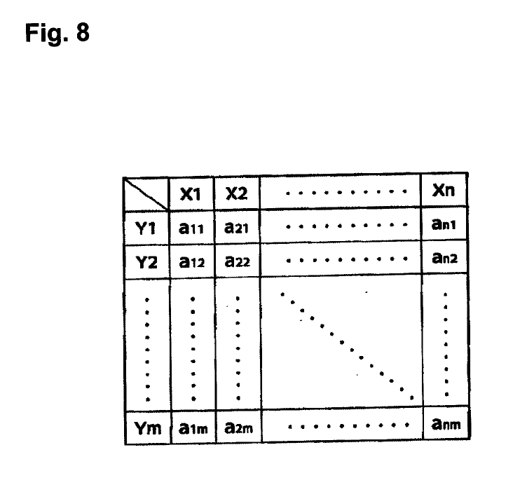

FIG. 8 is a table that shows a heat generation pattern to be formed when a certain operation is performed by the CPU 2. This heat generation pattern is an example, and may be modified in various ways.

FIG. 8 indicates amounts of heat generated at respective pixel positions corresponding to the data signal lines X1-Xn and the scanning signal lines Y1-Ym (see FIG. 2) on the liquid crystal panel 10, when the CPU 2 performs a certain operation. For example, an amount of heat a11 is generated at the position of the data signal line X1 and the scanning signal line Y1, and an amount of heat anm is generated at the position of the data signal line Xn and the scanning signal line Ym. The table of heat generation patterns is created in consideration of dispositions (positions on the substrate, distances to the liquid crystal display and the like), amounts of heat generation and heat resistances and the like of the devices that form the system.

By referring to such a table, an amount of heat generated at each of the pixel positions when a certain operation is performed at the CPU 2 can be readily obtained. It is noted that this table may preferably be prepared for each of different operations, and also for each of the cases when the communication section 13 performs communication with external apparatuses, and when the image processing section 4 performs image processing. It is noted that the tables of heat generation patterns are stored in the ROM 6 described above.

Next, a signal processing method for the liquid crystal display apparatus in accordance with the embodiment of the present invention will be described.

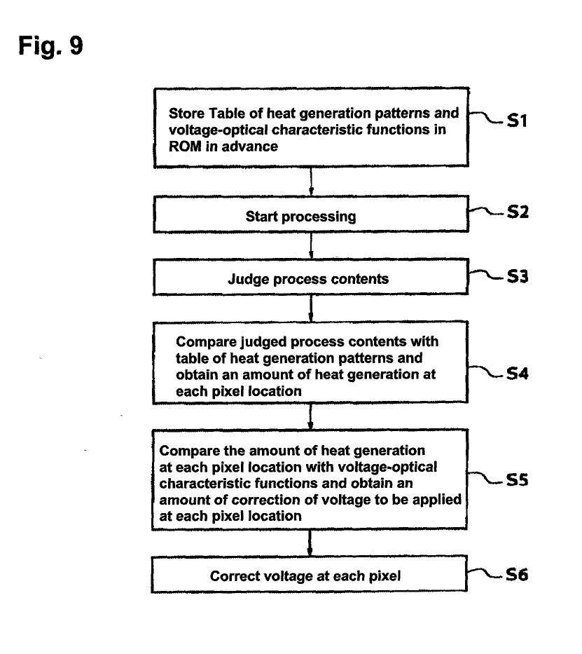

FIG. 9 is a flowchart of the signal processing method for the liquid crystal display apparatus in accordance with the embodiment of the present invention.

Referring to FIG. 9, first, tables of heat generation patterns (see FIG. 8) of the liquid crystal panel 10 disposed over the substrate 16 (see FIG. 6), and voltage-optical characteristic functions (or tables) of the two-terminal element 10b (see FIGS. 3-5) are stored in the ROM 1 (see FIG. 1) in advance (step 1).

As the process is started (step 2), the process content judging section 5 (see FIG. 1) judges process contents based on a task (thread, process) being currently executed (step 3).

The CPU 2 (see FIG. 1) compares the judged process contents with the table of heat generation patterns stored in the ROM 6, and obtains an amount of heat generation at each of the pixel locations (step 4).

Next, the image correction section 7 (see FIG. 1) compares the amount of heat generation at each of the pixel locations with the voltage-optical characteristic functions (or tables) of the two-terminal element 10b stored in the ROM 6, and obtains an amount of correction of voltage to be applied to each of the pixel locations (step 5).

The CPU transmits the amount of correction of voltage to be applied to the liquid crystal driver section 3 (see FIG. 1), whereby the voltage for each of the pixels is corrected (step 6).

It is clear from the above description that, in accordance with the present invention, display irregularities of liquid crystal can be reduced or suppressed, and higher quality display can be achieved without using thermal sensors.

What is claimed is:

1. A display apparatus, comprising:
a display device having a display characteristic that changes according to temperatures;
a driver device that drives the display device;
an image processing device that processes image data to be displayed on the display device;
a process content judging device that judges a process content based on a task of each of devises that form a system;
a storage device that stores a table of heat generation pattern of the display device and a display characteristic function (or table) of the display device according to the process content;
an image correction device that calculates a driving correction amount at each of pixels on the display device based on a judgment content provided by the process content judging device, the heat generation pattern and the display characteristic function; and
a control device that controls the system.

2. A signal processing method, comprising:
storing a table of heat generation pattern of a display device and a display characteristic function (or table) of the display device according to a task process content of each of devices that form a system;
judging the task process content during execution of the task;
comparing a process content judged with the table of heat generation pattern to calculate an amount of heat generation at each of pixel locations on the display device;
comparing the amount of heat generation at each of the pixel locations with the display characteristic function to obtain a driving correction amount at each of the pixel locations on the display device; and
correcting a driving amount for each of the pixels.
